(19) United States
(12) Patent Application Publication
(10) Pub. No.: US 2002/0173289 A1
(43) Pub. Date: Nov. 21, 2002

(54) Vehicle remote convenience receiver unit having multiple energy saving sleep modes

(75) Inventors: Ernest Edmond Pacsai, Wixom, MI (US); John R. Duquette, Brighton, MI (US)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Inc.

(21) Appl. No.: 09/858,095

(22) Filed: May 15, 2001

(51) Int. Cl. G08C 19/00

(52) U.S. Cl. 455/343; 340/825.69

(57) ABSTRACT

A remote convenience receiver unit (12), which is associated with a vehicle (16), receives a remote convenience signal (20) that conveys a remote convenience function request and causes performance of the requested function at the vehicle. The receiver unit (12) consumes a first amount of energy while awaiting reception of the remote convenience signal (20) at an ability to readily receive the remote convenience signal. A signal monitor and duty-cycle control (82) monitors duration of inactivity caused by a lack of receipt of a remote convenience signal (20), causes reduction of functional operation of the receiver unit (12) to consume a second, lesser amount of energy after a first duration of inactivity, and causes reduction of functional operation of the receiver unit to consume a third, lesser and different amount of energy after a second, different duration of inactivity.

### FIELD OF THE INVENTION

The present invention relates to a remote convenience system for remotely controlling a vehicle function, and specifically relates to a vehicle-based unit of the system that is configured to consume a reduce amount of electrical energy.

### BACKGROUND OF THE INVENTION

As vehicle sophistication increases, the amount of vehicle electrical devices increases. As a result of the increased amount of vehicle electrical devices, automotive manufacturers are requiring that each electrical device consume only a reduced amount of electrical energy. Such requirements help to prevent excessive battery drain.

The issue of battery drain becomes especially important for vehicle components that consume electrical energy during periods of vehicle inactivity (e.g., parking, storage, etc.). It is easily envisioned that a vehicle may have a protracted period of such inactivity. For example, a vehicle may be inactive during shipping from a vehicle manufacturer to a retail outlet, during storage (e.g., prior to sale or during inclement weather), or other factors (e.g., long-term airport parking while the vehicle owner is traveling afar).

One example of a component that consumes electrical energy during periods of vehicle inactivity is a remote convenience receiver unit based at the vehicle. The receiver unit is part of a vehicle remote convenience system.

In general, vehicle remote convenience systems are known in the art. Such remote convenience systems permit remote control of certain vehicle functions. Examples of remotely controlled functions include locking and unlocking of one or more vehicle doors. A remote convenience system that permits remote locking and unlocking functions is commonly referred to as a remote keyless entry system.

Such remote convenience systems may provide for control of other functions. For example, a remote vehicle locator function may be provided. The vehicle locator function causes the vehicle horn to emit a horn chirp and/or the headlights of the vehicle to flash “ON”. This allows a person to quickly locate their vehicle within a crowded parking lot. Another example is a vehicle component start function. The started component may be a vehicle engine, heater, etc.

In addition to the receiver unit mounted in an associated vehicle, the known remote convenience system includes at least one portable (e.g., hand-held) transmitter unit. Typically, the portable transmitter unit operates in the ultrahigh frequency (“UHF”) portion of the radio frequency (“RF”) spectrum. In order for the receiver unit to receive a signal from the transmitter unit, the receiver unit must be in an active receive state. An active receive state entails receive components of the receiver unit to be fully powered. It is to be appreciated that fully powering receive components requires a certain amount of consumption of electrical energy from the power source (e.g., the vehicle battery).

Currently, in order for a remote convenience receiver unit to provide good performance with regard to energy consumption, the receiver unit should draw only about 2-10 milliamps of current during periods of vehicle inactivity. However, some have forecast even tighter performance requirements for remote convenience receiver units. For example, it is not unreasonable to predict a future requirement of a remote convenience receiver unit drawing less than 300 microamps during periods of vehicle inactivity.

### SUMMARY OF THE INVENTION

In accordance with one aspect, the present invention provides a remote convenience receiver unit associated with a vehicle for receiving a remote convenience signal conveying a remote convenience function request and for causing performance of the requested function at the vehicle. The receiver unit consumes a first amount of energy while awaiting reception of the remote convenience signal at an ability to readily receive the remote convenience signal. Means monitors duration of inactivity caused by a lack of receipt of a remote convenience signal. Means reduces functional operation of the receiver unit to consume a second, lesser amount of energy after a first duration of inactivity. Means reduces functional operation of the receiver unit to consume a third, lesser and different amount of energy after a second, different duration of inactivity.

In accordance with another aspect, the present invention provides a remote convenience receiver unit associated with a vehicle for receiving a remote convenience signal conveying a remote convenience function request and for causing performance of the requested function at the vehicle. Means receives the remote convenience signal. The means for receiving is able to receive the remote convenience signal in response to provision of energy. Means monitors duration of inactivity caused by a lack of receipt of a remote convenience signal. Means duty-cycles energy to the means for receiving at a first rate after a first duration of inactivity. Means duty-cycles energy to the means for receiving at a second, different rate after a second, different duration of inactivity.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a block diagram representation of a remote convenience system that has a receiver unit in accordance with the present invention, and an associated vehicle;

FIG. 2 is a flow chart for a process performed within the receiver unit shown in FIG. 1; and

FIG. 3 is a plot showing energy consumption of a component of the receiver unit of FIG. 1.

### DESCRIPTION OF AN EXAMPLE EMBODIMENT

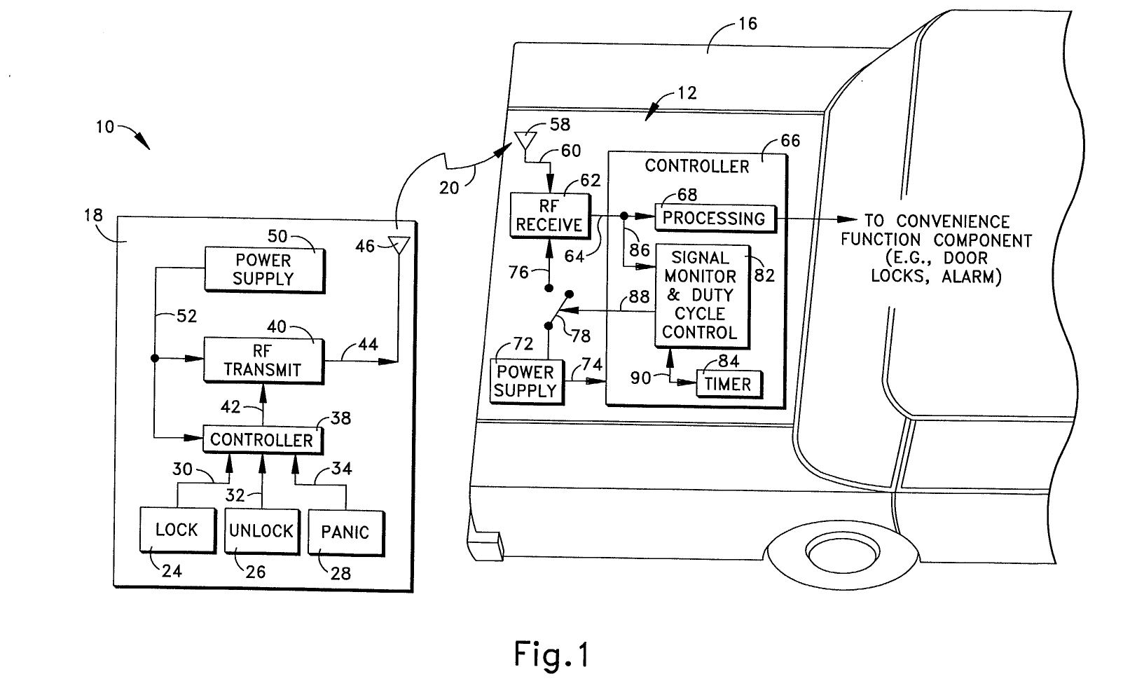

A remote convenience vehicle system 10 that includes an energy-saving remote convenience vehicle-based receiver unit 12 in accordance with the present invention is shown in FIG. 1. In the illustrated example of FIG. 1, the system 10 is for remote control performance of at least one convenience function (e.g., unlock doors) at a vehicle component (e.g., a vehicle door lock actuator) of a vehicle 16.

The system 10 includes a transmitter unit 18 that is operable to communicate, via a signal 20, with the vehicle-based receiver unit 12 to achieve remote control performance of the remote convenience function at the vehicle 16. A person (not shown, e.g., an owner of the vehicle 16) operates the transmitter unit 18 when the person desires performance of the remote convenience function at the vehicle. Within the example shown in FIG. 1, the receiver unit 12 and the transmitter unit 18 are not drawn to the scale of the vehicle 16 for the purpose of ease of illustration.

Focusing upon the transmitter unit 18, the unit is preferably a portable unit that has a relatively small size to permit carrying of the unit within a pocket, within a purse, or on a key chain. In the example shown in FIG. 1, the transmitter unit 18 has three pushbutton selector switches 24-28. A first pushbutton switch 24 and a second pushbutton switch 26 are associated with door lock and unlock functions, respectively. A third pushbutton switch 28 is associated with a vehicle alarm or “panic” function. It is to be appreciated that the remote convenience system 10 could be configured to control different remote convenience functions (e.g., vehicle locate) at the vehicle 16, and that system structure (e.g., the number and type of pushbutton switches on the transmitter unit) would be accordingly different.

Each actuation or predefined series of actuations of one of the pushbutton switches (e.g., 24) of the transmitter unit 18 is a request to perform a corresponding predefined remote convenience function. For example, actuating the first pushbutton switch 24 is a request to lock the doors of the vehicle 16. The pushbutton switches 24-28 are operatively connected 30-34 to provide input to a controller 38.

The controller 38 interprets the input and generates/assemblies a message “packet” of information to be transmitted. The message packet includes a start/wake-up portion, a security code, and at least one command that represents the remote function request. RF transmit circuitry 40 is operatively connected 42 to the controller 38. In response to receipt of the message packet from the controller 38, the RF transmit circuitry 40 generates a radio frequency electrical signal that conveys the message packet.

The RF transmit circuitry 40 is operatively connected 44 to an antenna 46. The signal from the RF transmit circuitry 40 is provided as a stimulus to the antenna 46, and in response to the electrical stimulus signal, the antenna broadcasts the signal 20 that is intended to be received by the receiver unit 12.

Within the transmitter unit 18, a power supply 50 provides electrical energy. The power supply 50 may take the form of a small, coin type battery. The power supply 50 is operatively connected 52 to the controller 38 and the RF transmit circuitry 40 such that appropriate electrical energy is provided and the components perform their respective functions.

At the receiver unit 12, an antenna 58 is operatively connected 60 to RF receive circuitry 62. In turn, the RF receive circuitry 62 is operatively connected 64 to a controller 66. Within the controller 66 is one or more components 68 that provide for processing of an electrical signal output by the RF receive circuitry 62 that conveys the message packet. The processing may be any suitable processing such as demodulation, security code comparison, determining of convenience function commands, etc. In response to the processing within the controller 66, an appropriate control signal is output to the appropriate vehicle system to cause performance of the requested convenience function.

A vehicle power supply 72 (e.g., a battery) provides electrical energy for the RF receive circuitry 62 and the controller 66 of the receiver unit 12. In the illustrated example, the controller 66 is connected 74 to the power supply 72 such that electrical energy is continuously provided to the controller 66. The RF receive circuitry 62 is connected 76 to the power supply 72 via a switch device 78 such that electrical energy is selectively provided to the RF receive circuitry. The switch device 78 may be any suitable switch device for permitting/preventing flow of electrical energy, such as a transistor.

It is to be appreciated that in order for the RF receive circuitry 62 to function (e.g., such that the signal 20 is received), electrical energy must be provided to the RF receive circuitry. A mode in which the RF receive circuitry is connected to receive electrical energy is referred to as an active mode.

Function of the RF receive circuitry consumes a fair amount of electrical energy. Thus, for certain portions of time, the switch device 78 is opened such that the RF receive circuitry 62 does not receive electrical energy and does not perform its function. In other words, the de-powering of the RF receive circuitry 62 is utilized to conserve electrical energy. Further, the de-powering/energy conservation occurs for portions of time in which receipt of the signal 20 from the transmitter unit 18 is less likely to occur. For example, long periods of inactivity (e.g., parked) of the vehicle 16 are typically associated with a very low possibility of the occurrence of the signal 20 from the transmitter unit 18.

Although FIG. 1 schematically illustrates the switch device 78 as providing/denying energy to the RF receive circuitry 62 as a total unit, it is to be appreciated that the powering/de-powering may be directed to the entire RF receive circuitry 62 or only portion(s) of the RF receive circuitry. Such portions of the RF receive circuitry that are powered/de-powered may include a preamplifier and a mixer.

It is to be noted that, at all times, a possibility of the occurrence of the signal 20 from the transmitter unit 18 exists. Accordingly, electrical energy is provided to the RF receive circuitry 62 based upon a predetermined powering schedule, with energy being provided for at least some time periods. Specifically, electrical energy is provided in a duty-cycle fashion (i.e., the switch device 78 is alternately turned ON/OFF). A mode in which energy is provided in a duty-cycled fashion is referred to as a sleep mode.

In order to accomplish the functions of determining whether to be in an active mode or a sleep mode, and to control provision of electrical energy to the RF receive circuitry, the controller 66 includes components 82 for monitoring receipt of the signal 20, as indicated by output from the RF receive circuitry 62, and for controlling the duty-cycling. Further, the controller 66 includes a timer function 84 for monitoring time durations since last signal receipt activity.

The signal monitor and duty-cycle control functions are illustrated via block diagram arrangement as a single component 82. However, it is to be appreciated that these functions may be provided by one or more suitable hardwired components, and/or a processing component performing one or more algorithms. Hereinafter, such components, and or algorithms are simply referred to as signal monitor and duty-cycle control 82.

The signal monitor and duty-cycle control 82 is operatively connected 86 to the output of the RF receive circuitry 62 and is operatively connected 88 to control the switch device 78. Also, the signal monitor and duty-cycle control 82 is operatively connected 90 to the timer function 84.

The signal monitor and duty-cycle control 82 monitors the RF receive circuitry output to determine when the signal 20 is being received. A watchdog circuit of the signal monitor and duty-cycle control 82 may be provided to make the determination regarding signal reception. Thus, while the signal 20 is actively being received, the signal monitor and duty-cycle control 82 controls the switch device 78 such that uninterrupted electrical energy is provided to the RF receive circuitry 62 (i.e., the switch device is ON). Similarly, for a period of time after receipt of the signal 20, the signal monitor and duty-cycle control 82 controls the switch device 78 such that uninterrupted electrical energy is provided to the RF receive circuitry 62. This permits the RF receive circuitry 62 to be fully active during a portion of time in which it is highly likely that additional (e.g., repeat) signal 20 will occur.

Once the signal 20 ceases, the signal monitor and duty-cycle control 82 activates the timer function 84. Thus, the duration of inactivity (e.g., lack of reception of the signal 20) is monitored.

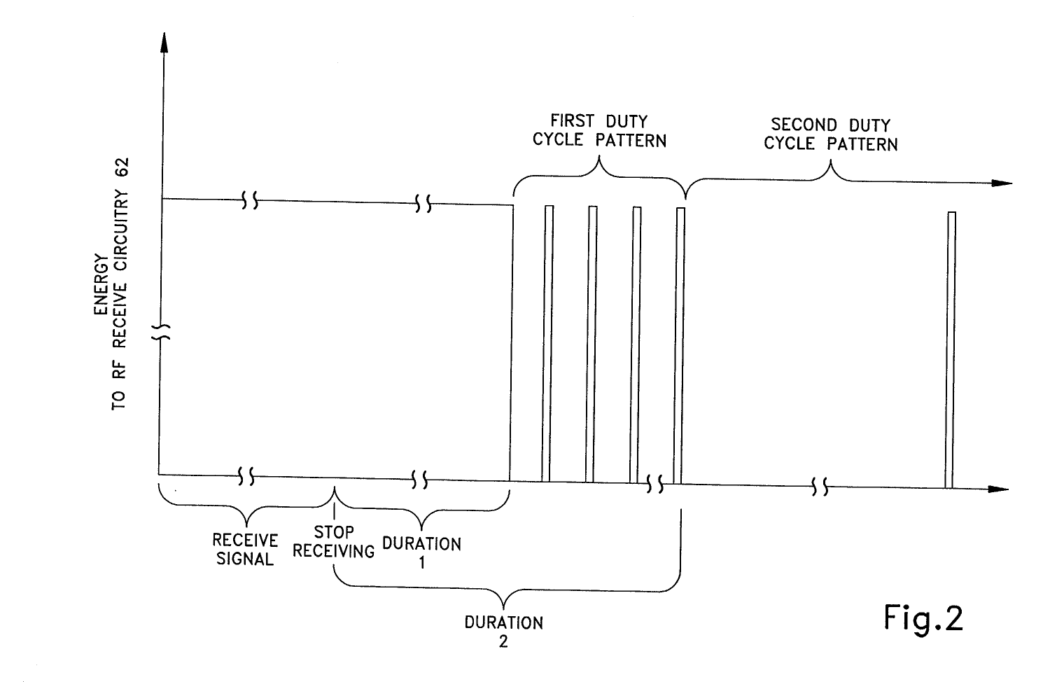

Turning again to issue of sleep mode, it is to be appreciated that a duty-cycling (ON/OFF) pattern of energy provision provides overall (e.g., average) savings in energy consumption. Specifically, energy is only consumed when the switch device 78 is ON (i.e., duty-cycled ON). Further, it is to be appreciated that the amount of energy consumed during duty-cycling is dependent upon the pattern of duty-cycling. With this in mind, it is to be noted that in accordance with the present invention, the signal monitor and duty-cycle control 82 provides for first and second, different, duty-cycling patterns (see FIG. 2).

During the first duty-cycling pattern, the cycle between ON and OFF is such that the energy is supplied to the RF receive circuitry 62 at a somewhat frequent interval. During the second duty-cycling pattern, electrical energy is provided to the RF receive circuitry 62 at a much less frequent interval.

The duty-cycling pattern that is employed at a particular point in time is dependent upon the duration of time since the last signal 20 (FIG. 1) was received. The first duty-cycling pattern occurs after a first duration (e.g., an hour) after the occurrence of the last received signal 20. The first duty-cycling rate is provided with the thought that there is still a fair likelihood that a subsequent signal 20 will soon be received. However, after a second duration (e.g., 100 hours), which is longer than the first duration, since the last received signal 20, it is much less likely that a subsequent signal 20 will soon be received. Such a scenario may occur during long term shipment or storage of the vehicle.

In one example, the first duty-cycle pattern (FIG. 2) consists of successive steps of no energy provision (i.e., the switch device is OFF) for approximately 30-40 milliseconds and energy provision (i.e., the switch device ON) for approximately ten milliseconds. Further in the example, the second duty-cycle pattern consists of successive steps of no energy provision (i.e., the switch device is OFF) for approximately 500 to 1,000 milliseconds and energy provision (i.e., the switch device is ON) for approximately 10 milliseconds. For the above-mentioned duty-cycling patterns, energy consumption is reduced by approximately 75 percent during the first duty-cycle pattern and energy consumption is reduced upwards of 95 percent for the second duty-cycle pattern.

It is to be noted that, depending upon duration of the signal 20 and the characteristics of a duty-cycling pattern, the signal 20 may only be partially received during energy provision to the RF receive circuitry 62 (i.e., the switch device ON time). Although, the conveyed message will not be discernable (i.e., insufficient data), the signal and duty-cycle control 82 still determines that signal reception occurs and accordingly controls the switch device 78 to close. As mentioned above, the switch device 78 is maintained closed for a period of time. Thus, the signal 20 need merely be repeated (i.e., re-actuation of the transmitter unit 18) within that period of time such that the receiver unit, with the RF receive circuitry 62 fully powered, receives the entire repeat signal 20.

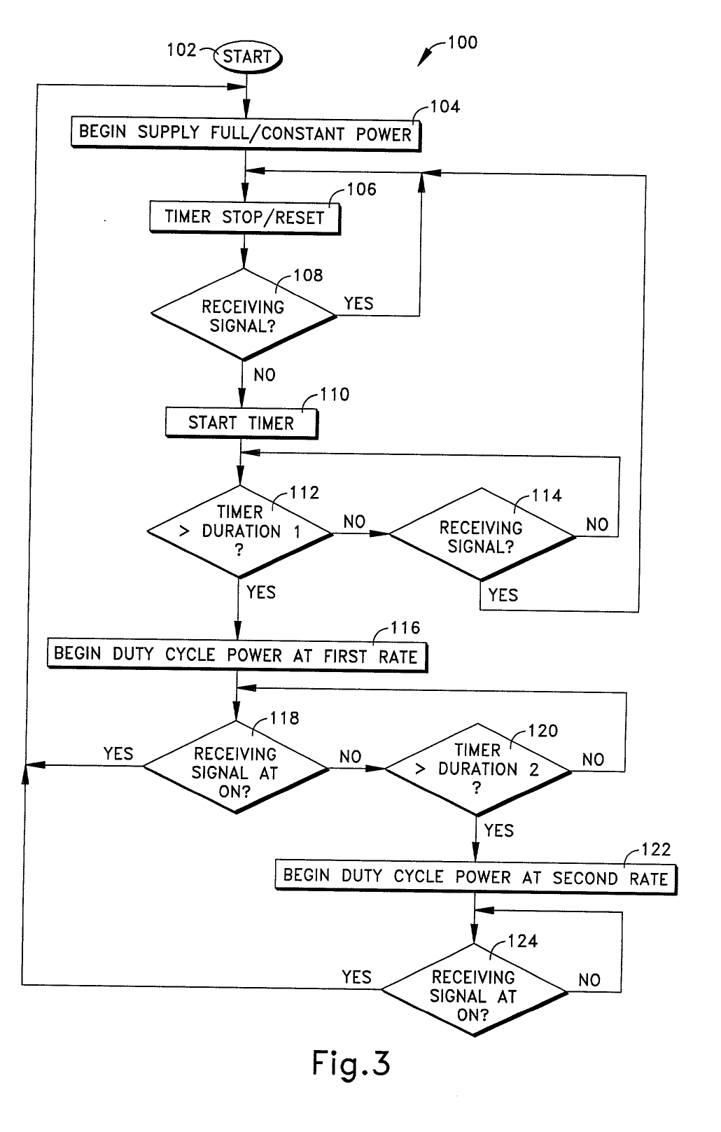

An example of a process 100 performed within the controller 66 is shown in FIG. 3. The process 100 is initiated at step 102 and proceeds to step 104. At step 104, the switch device 78 is controlled to be closed such that full/constant energy is provided to the RF receive circuitry 62. At step 106, the timer function 84 is stopped or reset to a zero duration. At step 108, it is queried whether the signal 20 from the transmitter unit 18 is being received. If the determination at step 108 is affirmative (e.g., the signal 20 is being received), the process 100 goes from step 108 to step 106. Accordingly, while the signal 20 is being received, the timer function 84 is maintained at a zero duration and full/constant energy is provided to the RF receive circuitry 62.

Upon the termination of receipt of the signal 20, the determination at step 108 will be negative. Upon the negative determination at step 108, the process 100 goes to step 110. At step 110, the timer function 84 is started to monitor the duration since termination of the most recently received signal 20.

At step 112, it is determined whether the timed period exceeds the first duration (e.g., one hour). If the determination at step 112 is negative (i.e., the timed period does not yet exceed the first duration in length), the process 100 proceeds from step 112 to step 114. At step 114, it is determined whether the receiver unit 12 is receiving another signal 20. If the determination at step 114 is negative (i.e., a signal 20 is not currently being received), the process 100 goes from step 114 to step 112. Thus, the process 100 enters a loop in which it is queried whether the timed period exceeds the first duration and also whether a signal 20 is being received.

It is to be noted that if within this loop a signal 20 is received, the determination at step 114 is affirmative. Upon the affirmative determination at step 114, the process 100 goes from step 114 to step 106. At step 106, the timer function 84 is reset and the process 100 again proceeds through the chain of steps extending from step 106.

If the process 100 continues to toggle through steps 112 and step 114 without receiving another signal 20 for a period of time that exceeds the first duration, the determination at step 112 is affirmative. Upon the affirmative determination at step 112 (i.e., have not received another signal 20 for the first duration of time), the process 100 proceeds to step 116. At step 116, the signal monitor and duty-cycle control 82 begins to control the switch device 78 to provide energy to the RF receive circuitry 62 at the first duty-cycling pattern rate.

Of course, during any ON portion provided during the duty-cycle, the receiver unit 12 may receive at least a portion of the transmitted signal 20. At step 118, it is determined whether the receiver unit 12 has received, albeit a portion, of the signal 20. If the determination at step 118 is affirmative (i.e., receipt of the signal 20), the process 100 loops from step 118 to step 104 in which the full/constant energy is provided to the RF receive circuitry 62. Process steps extending from step 104 are then performed.

Conversely, if the determination at step 118 is negative (i.e., receipt of the signal 20 does not occur during an ON portion of the first duty-cycle arrangement), the process 100 proceeds from step 118 to step 120. At step 120, it is determined whether the period since receipt of the last signal 20 has exceeded the second duration (e.g., 100 hours). If the determination at step 120 is negative (i.e., the second duration of time not yet expired), the process 100 proceeds from step 120 to step 118. Accordingly, the process 100 continues to loop through steps 118 and 120 while there is a lack of receipt of the signal 20 and until the timed period exceeds the second duration.

Upon exceeding the second duration, the determination at step 120 is affirmative. Upon the affirmative determination at step 120, the process 100 proceeds to step 122. At step 122, the signal monitor and duty-cycle control 82 causes the switch device 78 to provide energy accordingly to the second duty-cycle pattern.

At step 124, it is determined whether the signal 20 is received during an ON portion of the second duty-cycling period. If the determination at step 124 is negative (i.e., the signal 20 is not received), the process 100 continues to repeat step 124. Eventually, if the signal 20 is received during the ON portion, the determination at step 124 is affirmative. Upon the affirmative determination at step 124, the process 100 loops from step 124 to step 104 where full/constant energy is provided.

From the above description of the invention, those skilled in the art will perceive improvements, changes and modifications. Such improvements, changes and modifications within the skill of the art are intended to be covered by the appended claims.

Having described the invention, the following is claimed:

1. A remote convenience receiver unit associated with a vehicle for receiving a remote convenience signal conveying a remote convenience function request and for causing performance of the requested function at the vehicle, said receiver unit consuming a first amount of energy while awaiting reception of the remote convenience signal at an ability to readily receive the remote convenience signal, said receiver unit comprising:
means for monitoring duration of inactivity caused by a lack of receipt of a remote convenience signal;
means for reducing functional operation of said receiver unit to consume a second, lesser amount of energy after a first duration of inactivity; and
means for reducing functional operation of said receiver unit to consume a third, lesser and different amount of energy after a second, different duration of inactivity.

2. A receiver unit as set forth in claim 1, wherein said receiver unit includes receive circuitry that consumes energy during an ability to receive the remote convenience signal, said means for reducing functional operation of said receiver unit to consume a second amount of energy and means for reducing functional operation of said receiver unit to consume a third amount of energy include means for selectively providing electrical energy to said receive circuitry.

3. A receiver unit as set forth in claim 1, wherein said means for reducing functional operation of said receiver unit to consume a second amount of energy includes means for duty-cycling provision of energy according to a first pattern.

4. A receiver unit as set forth in claim 3, wherein said means for reducing functional operation of said receiver unit to consume a third amount of energy includes means for duty-cycling provision of energy according to a second, different pattern.

5. A receiver unit as set forth in claim 1, wherein the first duration of inactivity is a first duration of time without reception of the remote convenience signal, the second duration of inactivity is a second duration of time without reception of the remote convenience signal.

6. A receiver unit as set forth in claim 5, wherein the second duration of time is approximately 100 hours.

7. A remote convenience receiver unit associated with a vehicle for receiving a remote convenience signal conveying a remote convenience function request and for causing performance of the requested function at the vehicle, said receiver unit comprising:
means for receiving the remote convenience signal, said means for receiving being able to receive the remote convenience signal in response to provision of energy;
means for monitoring duration of inactivity caused by a lack of receipt of a remote convenience signal;
means for duty-cycling energy to said means for receiving at a first rate after a first duration of inactivity; and
means for duty-cycling energy to said means for receiving at a second, different rate after a second, different duration of inactivity.
